(19) United States
(12) Patent Application Publication
(10) Pub. No.: US 2016/0376054 A1
(43) Pub. Date: Dec. 29, 2016

(54) METHODS, CONTAINERS, AND SYSTEMS TO INCREASE SIDEWALL STRENGTH

(71) Applicant: Pactiv LLC, Lake Forest, IL (US)

(72) Inventors: William F. Patchen, Farmington, NY (US); Alan H. Forbes, Victor, NY (US)

(73) Assignee: Pactiv LLC, Lake Forest, IL (US)

(21) Appl. No.: 14/747,031

(22) Filed: Jun. 23, 2015

(51) Int. Cl. B65D 3/30; B31B 1/74

(52) U.S. Cl. CPC B65D 3/30; B31B 1/74; B31B 2201/621

(57) ABSTRACT

Method to increase strength of a rolled rim container having a sidewall defining a perimeter, a base at a first end of the sidewall, and an opening defined at a second end of the sidewall opposite the base. A portion of the sidewall at the second end is provided with or can be rolled to form a rolled rim. The rolled rim defines an interface along the perimeter between an outer surface of the sidewall and an exposed surface of the rolled rim. A bead material is applied along the interface between the exposed surface of the rolled rim and the outer surface of the sidewall. The bead material is cured to form a bead between the exposed surface of the rolled rim and the outer surface of the sidewall. Rolled rim containers and systems for forming the same are also disclosed.

### BACKGROUND

Field of the Disclosed Subject Matter

The present disclosed subject matter relates to a container having a rolled rim with increased strength, and to methods and systems to increase container sidewall strength, for example, paper or plastic containers.

Description of Related Art

Sidewall strength can impact the performance of containers, including, but not limited to, cups such as hot or cold beverage cups. Cups with insufficient sidewall strength, e.g., hoop strength, can flex when held, which can result in content spillage. Lid stability also can be impacted by cup strength. For example, a cup with insufficient sidewall strength can deform easily at the rim, which can result in poor lid retention.

Increasing the sidewall strength of a cup can be accomplished by increasing the stiffness of the feedstock. However, increased stiffness achieved by proportionately increasing the thickness and/or density of the feedstock can result in an increase of the weight and material cost of the cup.

Accordingly, there remains a need for a more efficient technique to increase the strength of a cup without significantly increasing material weight or costs.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a method to increase strength of a rolled rim container is disclosed. The method includes providing a container. The container has a sidewall defining a perimeter, a base at a first end of the sidewall, and an opening defined at a second end of the sidewall opposite the base. A portion of the sidewall at the second end is rolled to form a rolled rim container having a rolled rim. The rolled rim defines an interface along the perimeter between an outer surface of the sidewall and an exposed surface of the rolled rim. A bead material is applied along at least a portion of the outer surface of the sidewall. The bead material can be cured to form a bead between the exposed surface of the rolled rim and the outer surface of the sidewall.

As embodied herein, the container can be made of paper, plastic, composite, and/or suitable foams. For example, the container can be made of paper and can be laminated on at least one side of the paper. Additionally or alternatively, at least the sidewall of the container can be made of multiple walls separated by a gap.

For purpose of illustration and not limitation, the bead material can include at least one of a molten polymeric material, an emulsion, a solvent borne film-forming material, or a solid polymeric material. For example and not limitation, the bead material can include a polyester. The polyester can include polylactic acid (PLA). Additionally, the bead material further can include a solvent. The solvent can be at least one of acetone or methylene chloride (MeCl). As embodied herein, the bead material can be 10% PLA in acetone.

For example and not limitation, the bead material can be applied along the entire perimeter of the sidewall. Alternatively, the bead material can be applied along portions of the perimeter of the sidewall.

For purpose of illustration and not limitation, rolling the portion of the sidewall can occur before applying the bead material, and applying the bead material can include applying the bead material along the interface between the exposed surface of the rolled rim and the outer surface of the sidewall. Alternatively, applying the bead material can occur before rolling the portion of the sidewall, and applying the bead material can include applying the bead material along a portion of the outer surface of the sidewall where the interface will be defined upon rolling the portion of the sidewall to form the rolled rim.

As embodied herein, the bead material can be applied in fluid form. For example and not limitation, applying the bead material can include providing a dispenser to dispense the bead material and rotating the rolled rim container relative the dispenser to dispense the bead material along the interface between the sidewall and the rolled rim. For purpose of illustration and not limitation, the dispenser can be selected from at least one of an extruder, an injector, a pipette, a Pasteur pipette, an epoxy applicator, a glue applicator, a syringe, or an atomizer. Additionally or alternatively, applying the bead material can include spraying the bead material along the interface between the exposed surface of the rolled rim and the outer surface of the sidewall. For example, the bead material can be sprayed with an atomizer. Additionally or alternatively, applying the bead material can include immersing at least a portion of the interface in the bead material.

Additionally or alternatively, the bead material can be in a solid state. For example and not limitation, applying the bead material further can include applying the solid state bead material to the interface between the exposed surface of the rolled rim and the outer surface of the sidewall and melting, adhering, or expanding the solid state bead material to the interface between the exposed surface of the rolled rim and the outer surface of the sidewall.

For purpose of illustration and not limitation, the bead material can be applied at about 0.001-0.03 cubic centimeters (cc) of bead material per centimeter (cm). For purpose of illustration and not limitation, the bead material can be applied at about 0.002-0.02 cc of bead material per cm. Additionally or alternatively, the bead can include film webs or extensions extending along a portion of at least one of the exposed surface of the rolled rim or the outer surface of the sidewall.

As embodied herein, a strength to weight ratio of the rolled rim container having the bead formed between the exposed surface of the rolled rim and the outer surface of the sidewall can be increased by at least 5% compared to a similar rolled rim container without a bead (e.g., same dimensions, material construction, and shape). For example and not limitation, the strength to weight ratio of the rolled rim container having the bead formed between the exposed surface of the rolled rim and the outer surface of the sidewall can be increased by at least 10% or at least 20% compared to a similar rolled rim container without a bead.

In accordance with another aspect of the disclosed subject matter, a rolled rim container having increased strength is disclosed. The rolled rim container includes a sidewall having an outer surface defining a perimeter, a first end, and a second end. The second end has an opening defined thereat. A base is at the first end of the sidewall. A rolled rim is at the second end of the sidewall. The rolled rim has an exposed surface. Additionally, the rolled rim defines an interface along the perimeter between the outer surface of the sidewall and the exposed surface of rolled rim. A bead is formed at the interface between the exposed surface of the rolled rim and the outer surface of the sidewall.

As embodied herein, the sidewall, base, and rolled rim each can be made of at least one of paper or plastic. For example and not limitation, the sidewall can be made of paper. Additionally, the sidewall can be laminated on at least one of the outer surface or an inner surface.

For purpose of illustration and not limitation, the bead can include a bead material. For example, the bead material can include a polymeric material.

As embodied herein, the bead material can be applied in fluid form along the interface between the sidewall and the rolled rim. Additionally, the bead material further can include a solvent. For example and not limitation, the bead material can be applied at about 0.001-0.03 cc of bead material per cm or 0.002-0.02 cc of bead material per cm. Additionally or alternatively, the bead material can be applied in a solid state. For example and not limitation, the bead can be formed by melting, adhering, or expanding the solid state bead material to the interface between the sidewall and the rolled rim.

For example and not limitation, the bead can be formed along the entire perimeter of the sidewall. Alternatively, the bead can be formed along portions of perimeter of the sidewall. Additionally or alternatively, the bead can include film webs or extensions extending along a portion of at least one of the exposed surface of the rolled rim or the outer surface of the sidewall.

In accordance with another aspect of the disclosed subject matter, a system to increase strength of a rolled rim container is disclosed. The system includes a mandrel adapted to receive a rolled rim container. The rolled rim container has a sidewall defining a perimeter, a base at a first end of the sidewall, an opening defined at a second end of the sidewall opposite the base, and a rolled rim at the second end of the sidewall defining an interface along the perimeter between an outer surface of the sidewall and an exposed surface of the rolled rim. A dispenser is configured to apply a bead material along the interface between the sidewall and the rolled rim. The bead material can be curable to form a bead between the exposed surface of the rolled rim and the outer surface of the sidewall. Additionally, the mandrel and the dispenser can be rotatable relative to each other.

As embodied herein, the dispenser can be configured to apply the bead material along the entire perimeter of the sidewall. Alternatively, the dispenser can be configured to apply the bead material along portions of the perimeter of the sidewall.

For purpose of illustration and not limitation, the dispenser can be configured to apply the bead material at about 0.001-0.03 cc of bead material per cm or 0.002-0.02 cc of bead material per cm. For example, the dispenser can be configured to dispense the bead material along the interface between the sidewall and the rolled rim while the mandrel and the dispenser are rotating relative to each other. As embodied herein, the dispenser can be selected from at least one of an extruder, an injector, a glue applicator (e.g. a hot glue dispensing system), a pipette, a Pasteur pipette, an epoxy applicator, a syringe, or an atomizer. Additionally or alternatively, the dispenser can be configured to spray the bead material along the interface between the exposed surface of the rolled rim and the outer surface of the sidewall. For example and not limitation, the dispenser can be an atomizer to spray the bead material. Additionally or alternatively, the dispenser can be configured to immerse at least a portion of the interface in the bead material.

For example and not limitation, the bead material can be in a solid state. The dispenser can be configured to apply the solid state bead material to the interface between the sidewall and the rolled rim. Additionally, at least one of a heat source or an adhesive source can be provided to secure the solid state bead material to the interface between the sidewall and the rolled rim.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a schematic diagram illustrating a representative system according to an illustrative embodiment of the disclosed subject matter.

FIGS. 2A-C each is a flow chart which collectively illustrate representative methods according to the disclosed subject matter.

FIG. 3 is a cross sectional schematic side view of a representative rolled rim container according to illustrative embodiments of the disclosed subject matter.

FIG. 3A is a cross sectional schematic view of the section indicated in FIG. 3.

FIGS. 4A, 4B, and 4C each is a cross-sectional side view of an exemplary bead at an interface between a rolled rim and a sidewall of a representative rolled rim container according to illustrative embodiments of the disclosed subject matter.

### DETAILED DESCRIPTION

Reference will now be made in detail to the various exemplary embodiments of the disclosed subject matter, exemplary embodiments of which are illustrated in the accompanying drawings. The containers and corresponding methods of the disclosed subject matter will be described in conjunction with the detailed description of the system.

The methods, containers, and systems presented herein can be used to increase container sidewall strength. The disclosed subject matter is particularly suited to a container having a rolled rim with increased strength, and to methods and systems to increase container sidewall strength, for example, paper or plastic containers.

In accordance with an aspect of the disclosed subject matter, a method to increase strength of a rolled rim container is disclosed. The method includes providing a container having a sidewall defining a perimeter, a base at a first end of the sidewall, and an opening defined at a second end of the sidewall opposite the base. A portion of the sidewall at the second end is rolled to form a rolled rim container having a rolled rim. The rolled rim defines an interface along the perimeter between an outer surface of the sidewall and an exposed surface of the rolled rim. A bead material is applied along the interface between the exposed surface of the rolled rim and the outer surface of the sidewall. The bead material can be cured to form a bead between the exposed surface of the rolled rim and the outer surface of the sidewall.

In accordance with another aspect of the disclosed subject matter, a rolled rim container having increased strength is disclosed. The rolled rim container includes a sidewall having an outer surface defining a perimeter, a first end, and a second end. The second end has an opening defined thereat. A base is at the first end of the sidewall. A rolled rim is at the second end of the sidewall. The rolled rim has an exposed surface. Additionally, the rolled rim defines an interface along the perimeter between the outer surface of the sidewall and the exposed surface of rolled rim. A bead is formed at the interface between the exposed surface of the rolled rim and the outer surface of the sidewall.

In accordance with another aspect of the disclosed subject matter, a system to increase strength of a rolled rim container is disclosed. The system includes a mandrel adapted to receive a rolled rim container. The rolled rim container has a sidewall defining a perimeter, a base at a first end of the sidewall, an opening defined at a second end of the sidewall opposite the base, and a rolled rim at the second end of the sidewall defining an interface along the perimeter between an outer surface of the sidewall and an exposed surface of the rolled rim. A dispenser is configured to apply a bead material along the interface between the sidewall and the rolled rim. The bead material can be curable to form a bead between the exposed surface of the rolled rim and the outer surface of the sidewall. Additionally, the mandrel and the dispenser can be rotatable relative to each other.

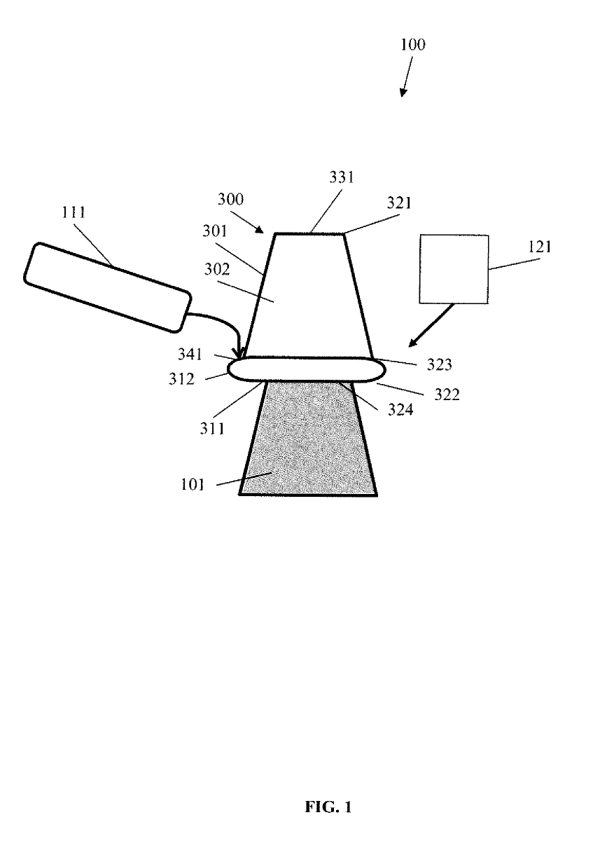

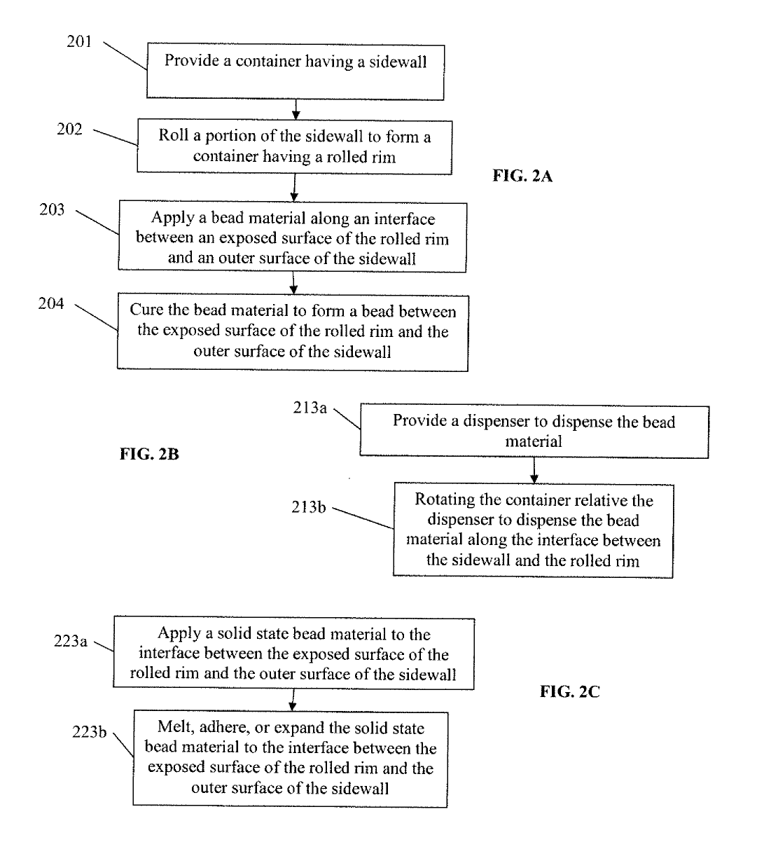

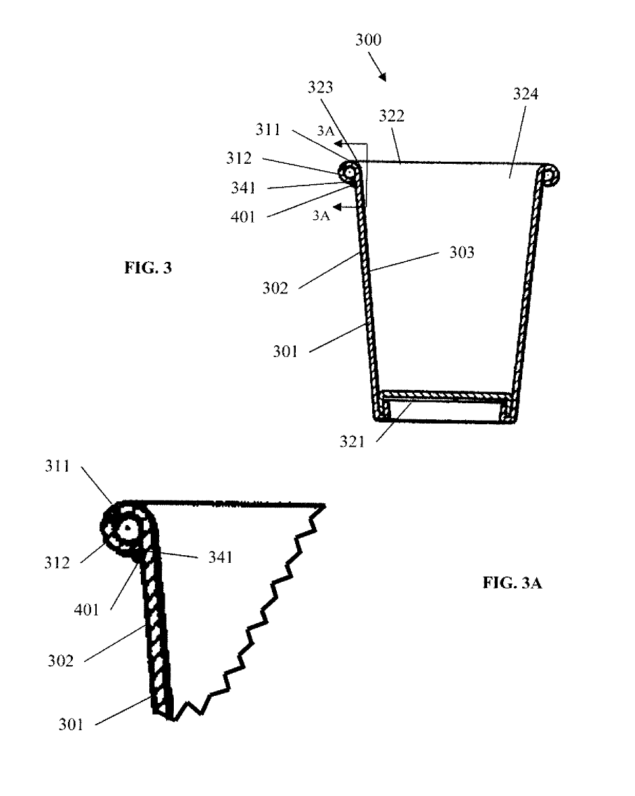

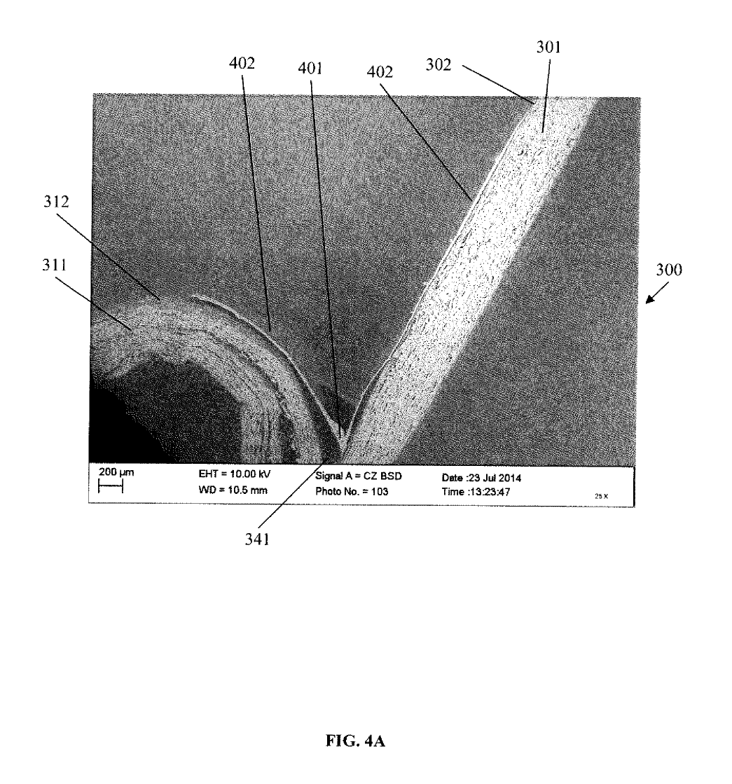

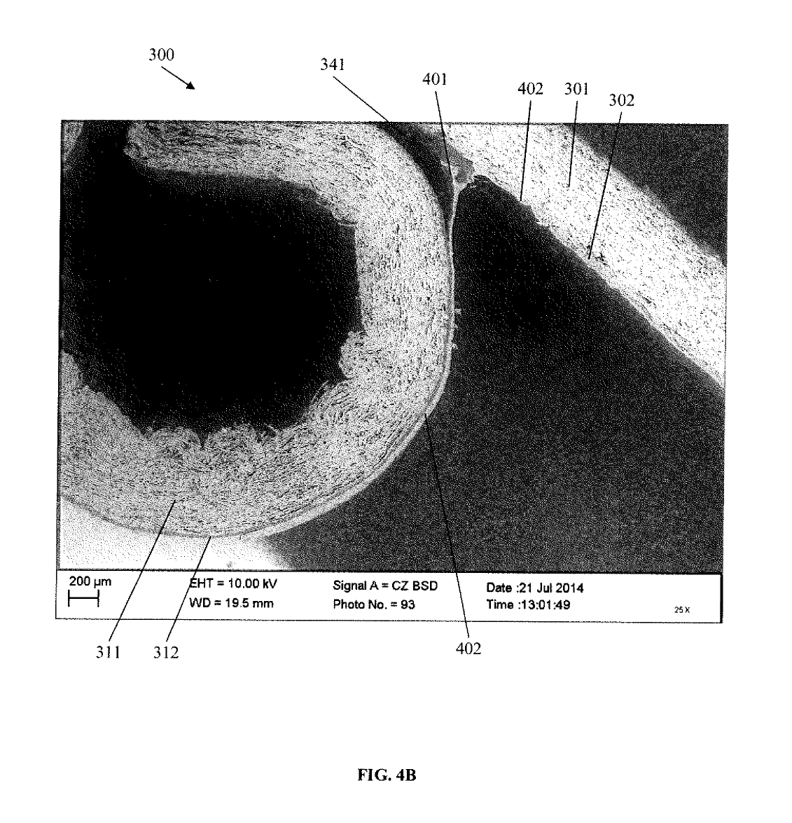

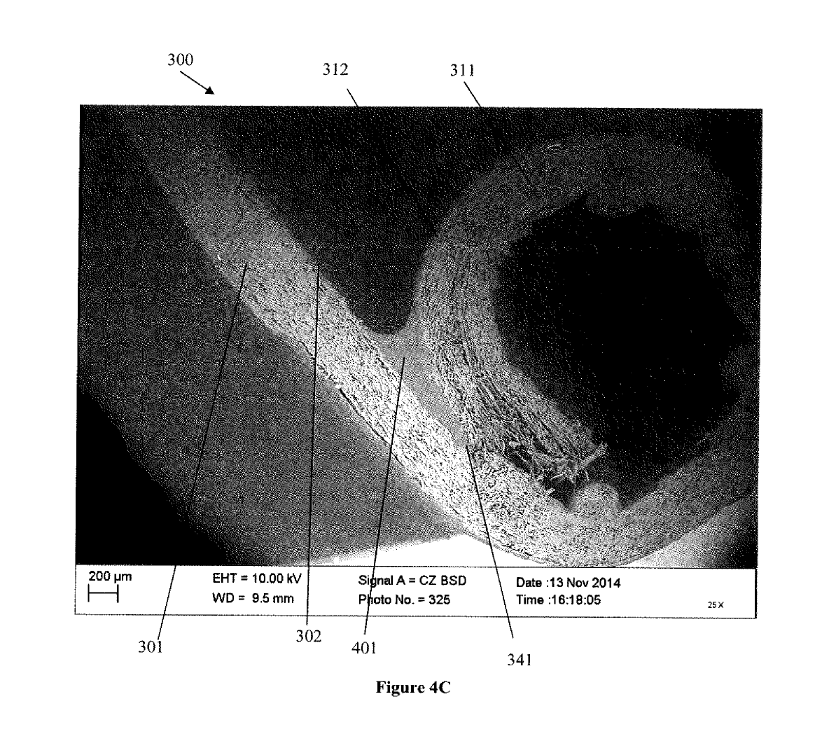

The accompanying figures, where like reference numerals refer to identical or functionally similar elements throughout the separate views, serve to further illustrate various embodiments and to explain various principles and advantages all in accordance with the disclosed subject matter. For purpose of explanation and illustration, and not limitation, a schematic diagram illustrating a representative system in accordance with the disclosed subject matter is shown in FIG. 1. Flow charts which collectively illustrate representative methods according to the disclosed subject matter are shown in FIGS. 2A-C. A cross sectional schematic side view of a representative rolled rim container in accordance with the disclosed subject matter is shown in FIG. 3, a cross sectional schematic view of the section indicated in FIG. 3 is shown in FIG. 3A, and a cross-sectional side view of an exemplary bead at an interface between a rolled rim and a sidewall of a representative rolled rim container in accordance with the disclosed subject matter is shown in each of FIGS. 4A-C.

The methods, containers, and systems described herein are suitable for use with a wide variety of containers. However, for purpose of understanding, reference is made to rolled rim containers having a rolled rim, such as a cup or the like. Such cups with rolled rims are generally disclosed in U.S. Pat. No. 3,144,971, which is incorporated by reference herein in its entirety. For purpose of illustration and not limitation, the rolled rim containers described herein can be formed from any material suitable for containers including paper, paper laminated on at least one side, multiple-walled paper, plastic and other polymers, suitable composite materials, and/or suitable foams. That is, the disclosed subject matter is suitable for increasing the sidewall strength of a wide variety of paper or plastic containers. For purpose of illustration and not limitation, a cup can be made up of any suitable material, including, but not limited to, paper or plastic such as polystyrene, polypropylene, polyester, polylactic acid, or combinations thereof. Additionally, fillers, laminates, or multiple layers or walls can be incorporated into the cup.

In the exemplary embodiment shown in FIG. 1, a system 100 to increase strength of a rolled rim container generally can include a mandrel 101 adapted to receive a rolled rim container 300. For purpose of illustration and not limitation, the rolled rim container 300 can have a sidewall 301 defining a perimeter 323, a base 331 at a first end 321 of the sidewall 301, and an opening 324 defined at a second end 322 of the sidewall 301 opposite the base 331. The container can be provided with a rolled rim 311 at the second end 322, or the system 100 can further include a screw assembly or the like to form the rolled rim as described and known in the art. The rolled rim 311 at the second end 322 of the sidewall 301 defines an interface 341 along the perimeter 323 between an outer surface 302 of the sidewall 301 and an exposed surface 312 of the rolled rim 311.

As embodied herein, the system 100 includes a dispenser 111 configured to apply a bead material along the interface 341 between the sidewall 301 and the rolled rim 311. For example and not limitation, the bead material can be curable to form a bead between and connecting the exposed surface 312 of the rolled rim 311 and the outer surface 302 of the sidewall 301, as described herein. The mandrel 101 and the dispenser 111 can be rotatable or otherwise movable relative to each other to allow the bead material to be dispensed from the dispenser 111 along at least a portion of the rolled rim container perimeter 323.

For example and not limitation, the bead material can be applied to the sidewall 301 of the rolled rim container 300 before or after the portion of the sidewall 301 is rolled to form the rim 311. Additionally or alternatively, the bead material can be in a cured or uncured state when the rolled rim 311 is formed, and the bead material can be cured before or after the rolled rim 311 is formed.

For purpose of illustration and not limitation, the dispenser 111 can be configured to apply the bead material along the entire perimeter 323 of the sidewall 301. Alternatively, the dispenser 111 can be configured to apply the bead material along portions of the perimeter 323 of the sidewall 301.

Additionally, the dispenser 111 can be configured to apply a suitable amount of bead material. For example and not limitation, the dispenser 111 can be configured to apply the bead material at about 0.001-0.03 cc of bead material per cm or 0.002-0.02 cc per cm. For purpose of illustration and not limitation, an exemplary rolled rim container 300 can have a diameter of 3.5 inches at the second end 322 near the rolled rim 311 and a diameter of 2.5 inches at the first end 321 near the base 331. Additionally, an exemplary rolled rim container 300 can have a height of about 4-6 inches.

As embodied herein, and for illustration only, the dispenser 111 can be configured to dispense the bead material along the interface 341 between the sidewall 301 and the rolled rim 311 while the mandrel 101 and the dispenser 111 are rotating relative to each other. For example, if the bead material is applied initially in fluid form, the dispenser 111 can be any suitable dispenser, including, but not limited to, at least one of an extruder, an injector, a glue applicator (e.g. a hot glue dispensing system), a pipette, a Pasteur pipette, an epoxy applicator, or a syringe. A suitable device to assist in curing of the bead material to form the bead can be provided, such as an air jet or the like, if desired. Additionally or alternatively, the dispenser 111 can be configured to spray the bead material along the interface 341 between the exposed surface 312 of the rolled rim 311 and the outer surface 302 of the sidewall 301. For example and not limitation, the dispenser 111 can be an atomizer to spray the bead material. Additionally or alternatively, the dispenser 111 can be configured to immerse at least a portion of the interface 341 in the bead material. For example and not limitation, the dispenser 111 can be a container of bead material into which at least a portion of the rolled rim container 300 including at least a portion of the interface 341 can be submerged, thereby immersing at least a portion of the interface 341 in the bead material.

Additionally or alternatively, the bead material can be applied in a solid state. For example and not limitation, the dispenser 111 can be configured to apply, in the form of a tape, strip, or particulates in a suitable binder, the solid state bead material to the interface 341 between the sidewall 301 and the rolled rim 311. For purpose of illustration and not limitation, a heat and/or adhesive source 121 can melt and/or adhere the solid state bead material to the interface 341 between the sidewall 301 and the rolled rim 311. For example and not limitation, any heat source 121 suitable to melt the solid state bead material can be used, including but not limited to direct contact, convective, radiative, microwave, or inductive heating. Additionally or alternatively, any adhesive source 121 suitable to adhere the solid state bead material can be used, including, but not limited to, an adhesive dispenser such as for hot melt adhesive, water based glue, solvent based glue, radiation curable glue, and/or suitable foams. Additionally or alternatively, the solid state bead material can be expanded to conform to the interface.

For purpose of illustration and not limitation, multiple rolled rim containers 300 can be strengthened simultaneously. For example, multiple systems 100 can operate in parallel. Additionally or alternatively, the system 100 can include a plurality of mandrels 101 to support a plurality of rolled rim containers 300 and can include one or more dispensers 111 and one or more heat and/or adhesive sources 121 as desired or needed to process the plurality of rolled rim containers 300 simultaneously.

Once the bead material is applied and cured to form the bead, the bead can increase the sidewall strength of the rolled rim container 300. For purpose of illustration and not limitation, the increase in sidewall strength can be disproportionate compared to the weight of the bead material added, as described below. As embodied herein, a strength to weight ratio of the rolled rim container having the bead formed between the exposed surface of the rolled rim and the outer surface of the sidewall can be increased by at least 5% compared to a similar rolled rim container without a bead (e.g., same dimensions, material construction, and shape). For example and not limitation, the strength to weight ratio of the rolled rim container having the bead formed between the exposed surface of the rolled rim and the outer surface of the sidewall can be increased by at least 10% or at least 20% compared to a similar rolled rim container without a bead.

FIGS. 2A-C each is a flow chart which collectively illustrate representative methods to increase strength of a rolled rim container according to the disclosed subject matter. The exemplary methods of FIGS. 2A-C, for purpose of illustration and not limitation, are discussed with reference to the exemplary system of FIG. 1. Referring to FIG. 2A, at 201 a container is provided. For example and not limitation, the container can have a sidewall 301 defining a perimeter 323, a base 331 at a first end 321 of the sidewall 301, and an opening 324 defined at a second end 322 of the sidewall 301 opposite the base 331.

As embodied herein, at 202, a portion of the sidewall 301 at the second end 322 is provided with a rolled rim. For example and not limitation, the method can include rolling the second end 322 to form a rolled rim container 300 having a rolled rim 311, as described herein. In this manner, the rolled rim 311 defines an interface 341 along the perimeter 323 between an outer surface 302 of the sidewall 301 and an exposed surface 312 of the rolled rim 311.

Further in accordance with the disclosed subject matter, at 203, a bead material is applied along at least a portion of the outer surface 302 of the sidewall 301, as described herein. For example, and as previously described with referenced to the disclosed systems, the bead material can be applied in fluid form and/or in solid form. At 204, the bead material can be cured, dried, crosslinked, and/or cooled to form a bead between the exposed surface 312 of the rolled rim 311 and the outer surface 302 of the sidewall 301.

As embodied herein, the container can be made of any suitable material, including, but not limited to, paper, plastic, composite, or foams thereof. For purpose of illustration and not limitation, the container can be made of paper. Additionally, the paper container can be laminated on at least one side of the paper. Additionally or alternatively, the sidewall can be a multi-wall structure, for example, multi-wall paper or plastic. For example, at least the sidewall 301 of the container can be made of multiple walls separated by a gap. For purpose of illustration and not limitation, the sidewall 301 can be made of a multilayer coextruded or laminated plastic.

For purpose of illustration and not limitation, the bead material can include any suitable material, including, but not limited to, at least one of a molten polymeric material, an emulsion, a solvent borne film-forming material, or a solid polymeric material. For example and not limitation, suitable molten polymeric materials can include, but are not limited to, polylactic acid (PLA), polystyrene (PS), high-impact polystyrene (HIPS), polypropylene (PP), poly(methyl methacrylate) (PMMA), polycarbonate (PC), poly(p-phenylene oxide) (PPO), polyurethane, wax (e.g. polyethylene wax), ethylene vinyl acetate (EVA), polyethylene (PE), thermal inks, expandable materials, expandable adhesives, or foams thereof. Suitable emulsions can include, but are not limited to, a latex. Suitable solvent borne film-forming materials can include, but are not limited to, PLA in acetone, PLA, cellulosic polymers, PMMA, polyurethane (PU), or PS. Suitable solid polymeric materials can include, but are not limited to, PLA, PS, PP, PE, PMMA, EVA, polyethylene terephthalate (PET), or PU. The aforementioned materials can also include suitable fillers including but not limited to a mineral filler.

As embodied herein, for purpose of illustration, the bead material can include a polyester. For example and not limitation, the polyester can include polylactic acid (PLA). Additionally, the bead material further can include a solvent. For example and not limitation, the solvent can include at least one of acetone or methylene chloride (MeCl). For purpose of illustration and not limitation, the bead material can be made of 10-20% PLA in acetone at room temperature or up to 25% or more PLA in acetone at elevated temperatures. For example, the bead material can be made of 10% PLA in acetone.

For example and not limitation, the bead material can be applied along the entire perimeter 323 of the sidewall 301. Alternatively, the bead material can be applied along portions of the perimeter 323 of the sidewall 301.

For purpose of illustration and not limitation, rolling the portion of the sidewall (202) can occur before applying the bead material (203), and applying the bead material (203) can include applying the bead material along the interface 341 between the exposed surface 312 of the rolled rim 311 and the outer surface 302 of the sidewall 301. Alternatively, applying the bead material (203) can occur before rolling the portion of the sidewall 301 (202), and applying the bead material (203) can include applying the bead material along a portion of the outer surface 302 of the sidewall 301 where the interface 341 will be defined upon rolling the portion of the sidewall 301 to form the rolled rim 311.

As embodied herein, the bead material can be applied in fluid form. For purpose of illustration and not limitation, referring to FIG. 28, at 213a, applying the bead material can include providing a dispenser 111 to dispense the bead material, as described herein. For example, the dispenser can be any suitable dispenser, as described herein, including, but not limited to, at least one of an extruder, an injector, a glue applicator (e.g. a hot glue dispensing system), a pipette, a Pasteur pipette, an epoxy applicator, a syringe, or an atomizer. Additionally or alternatively, applying the bead material can include spraying the bead material along the interface 341, as described herein. For example, the bead material can be sprayed with an atomizer. Additionally or alternatively, applying the bead material can include immersing at least a portion of the interface 341 in the bead material, as described herein. At 213b, the rolled rim container 300 can be rotated relative the dispenser 111 to dispense the bead material along the interface 341 between the sidewall 301 and the rolled rim 311.

Alternatively, for purpose of illustration and not limitation, the bead material can be in a solid state. For purpose of illustration and not limitation, referring to FIG. 2C, at 223a, applying the bead material further can include applying the solid state bead material in the form of a tape, a strip, or particulates in a suitable binder to the interface 341 between the exposed surface 312 of the rolled rim 311 and the outer surface 302 of the sidewall 301, as described herein. At 223b, the solid state bead material can be melted, adhered, expanded or otherwise secured to the interface 341 between the exposed surface 312 of the rolled rim 311 and the outer surface 302 of the sidewall 301, as described herein.

For purpose of illustration and not limitation, the bead material can be applied before or after rolling the rim, as described herein. Additionally or alternatively, the bead material can be cured before or after rolling the rim, as described herein.

For purpose of illustration and not limitation, a suitable amount of bead material can be applied to the interface 341 between the exposed surface 312 of the rolled rim 311 and the outer surface 302 of the sidewall 301, as described herein. For example and not limitation, the bead material can be applied at about 0.001-0.03 cc of bead material per cm or 0.002-0.02 cc of bead material per cm, as described herein. Additionally or alternatively, as embodied herein, the bead can include film webs/extensions extending along a portion of at least one of the exposed surface 312 of the rolled rim 311 or the outer surface 302 of the sidewall 301, as described herein.

FIG. 3 shows cross sectional schematic side view of a representative rolled rim container in accordance with the disclosed subject matter, and FIG. 3A shows a cross sectional schematic view of the section indicated in FIG. 3. For purpose of illustration and not limitation, a rolled rim container 300 includes a sidewall 301 having an outer surface 302 and defining a perimeter 323, a first end 321 having a base 331 formed thereat, and a second end 322 defining an opening. A rolled rim 311 is provided or otherwise formed at the second end 322 of the sidewall 301. The rolled rim 311 has an exposed surface 312 defines an interface 341 along the perimeter 323 between the outer surface 302 of the sidewall 301 and the exposed surface 312 of rolled rim 311. A bead 401 is formed at the interface 341 between the exposed surface 312 of the rolled rim 311 and the outer surface 302 of the sidewall 301, as described above.

For example, and as embodied herein, the sidewall 301, base 331, and rolled rim 311 each can be made of any suitable material, including, but not limited to, at least one of paper or plastic, as described herein. For example and not limitation, the sidewall 301 can be made of paper. Additionally, the sidewall 301 can be laminated on at least one of the outer surface 302 or an inner surface 303. Additionally or alternatively, the sidewall can consist of multiple layers of paper separated by a gap, as described herein.

For example, and as previously described with referenced to the disclosed systems, the bead material can be applied in fluid form and/or in solid form. For purpose of illustration and not limitation, the bead 401 can include any suitable bead material, as described herein. As embodied herein, for purpose of illustration, the bead material can include a polyester. For example and not limitation, the polyester can include polylactic acid (PLA). Additionally, the bead material further can include a solvent. For example and not limitation, the solvent can include at least one of acetone or methylene chloride (MeCl). For purpose of illustration and not limitation, the bead material can be made of 10% PLA in acetone.

For purpose of illustration and not limitation, a suitable amount of bead material can be applied, as described herein. For example, the bead material can be applied at about 0.001-0.03 cc of bead material per cm or 0.002-0.02 cc of bead material per cm.

Alternatively, for purpose of illustration and not limitation, the bead material can be applied in a solid state, e.g., in the form of a tape, a strip, or particulates in a suitable binder, as described herein. Additionally, the bead 401 can be formed by melting, adhering, expanding, or otherwise securing the solid state bead material to the interface 341 between the sidewall 301 and the rolled rim 311, as described herein.

As embodied herein, the bead 401 can be formed along the entire perimeter of the sidewall. Alternatively, the bead 401 can be formed along portions of perimeter of the sidewall.

FIGS. 4A-C each show an exemplary embodiment of a bead 401 in cross-sectional side view at an interface 341 between a rolled rim 311 and a sidewall 301 of a representative rolled rim container 300 in accordance with the disclosed subject matter, as described herein. For purpose of illustration and not limitation, the bead material can include a variety of suitable materials, including, but not limited to, PLA, PS, epoxy, hot melt glue (e.g., LD Davis BT599)], dextrin-based glue (e.g., LD Davis AW350), wax, polywax, wax/EVA, HIPS, and/or suitable foams. Additionally, the bead material can include a variety of suitable solvents or carriers, including, but not limited to, acetone, MeCl, and water. The bead material can be added to the interface 341 between the exposed surface 312 of the rolled rim 311 and the outer surface 302 of the sidewall 301, as described herein. Once cured as described above, and as depicted in FIGS. 4A-B, the bead 401 can include film webs/extensions 402 extending along a portion of at least one of the exposed surface 312 of the rolled rim 311 or the outer surface 302 of the sidewall 301. For example, and as embodied herein, the web 402 can extend along portions of both the exposed surface 312 of the rolled rim 311 and the outer surface 302 of the sidewall 301.

The system and method of the disclosed subject matter provides a rolled rim container having enhanced strength and enhanced strength to weight ratio. That is, the formation of a suitable bead 401 along the interface 341 can enhance the sidewall strength of the rolled rim container. Additionally, the resulting increase in sidewall strength can be disproportionate to the weight of the reinforcing material added, thereby increasing the strength-to-weight ratio of the cup. For example and not limitation, as described below, a 0.4% increase in weight added can correspond to up to a 30% increase in sidewall strength or more. As embodied herein, the weight of a rolled rim container can be reduced and/or the amount of material used and corresponding cost of the rolled rim container can be reduced while maintaining or increasing the sidewall stiffness of the rolled rim container. The bead 401 also can improve lid retention. Additionally, the magnitude of the increase in stiffness relative to the weight of the bead material added as described herein can be disproportionate compared to a bead or band of stiff material around a different portion of the rolled rim container, as described below.

To facilitate a better understanding of the present disclosure, the following examples of certain aspects of preferred embodiments are given. The following examples are not the only examples that could be given according to the present disclosure and are not intended to limit the scope of the disclosure or claims. Based upon the above, rolled rim containers in accordance with the disclosed subject matter herein can be provided with enhanced sidewall strength relative to rolled rim containers of similar configuration but without a bead in accordance with the disclosed subject matter.

For purpose of understanding and not limitation, an exemplary double laminated 16 ounce two-piece paper cup was reinforced using the system and method disclosed herein with amorphous polylactic acid (PLA), e.g., commercially available PLA such as Natureworks 4060D. The PLA was dissolved in acetone at a 10% by weight concentration to form an exemplary suitable bead material, as described herein. Various target volumes of the bead material were applied to the interface 341 between the exposed surface 312 of the rolled rim 311 and the outer surface 302 of the sidewall 301 of exemplary cups by placing each cup on a rotating mandrel 101 and dispensing the target volume of bead material at the interface 341 between the exposed surface 312 of the rolled rim 311 and outer surface 302 sidewall 301 with a suitable dispenser, e.g., a Pasteur pipette. The bead material was cured, e.g., by allowing the bead material to dry under ambient conditions for 24 hours. Cup strength was then measured by deflecting the sidewall of the cup 0.25 inches at a location ⅓ the cup height from the top of the cup. For example, an exemplary paper cup had a height of 12 cm, so deflection was measured 4 cm from the rolled rim 311. The resulting measurements were then compared to a control cup (e.g. a cup without any bead added) and/or to a cup having a bead or band of material formed near, but not connecting to, the rolled rim 311. Tables 1A and 1B show the results of such testing, which demonstrate a significant improvement in sidewall stiffness compared to a relatively low weight of material added.

TABLE 1A
Double Laminated 16 oz. Paper Cup (Cold Cup), 14 point (10 g)

| | | | | | | | Percent |
|---|---|---|---|---|---|---|---|
| | | | | | | | Strength |
| | | | | | | | increase/ |
| | Volume | Avg. Cup | Weight | | Percent | Percent | Percent |
| | Reinforcing | Weight | Added | Strength | Weight | Strength | Weight |
| Bead Material | agent (cc) | (g) | (g) | (lbs) | Increase | Increase | Increase |
| None - Control | 0.00 | 10.16 | 0.00 | 0.40 | | | |
| 10% PLA in Acetone | 0.25 | 10.15 | 0.03 | 0.40 | 0.2% | 0.5% | 2.1 |
| Band, not connecting rim | | | | | | | |
| 10% PLA in Acetone | 0.25 | 10.16 | 0.03 | 0.45 | 0.2% | 13.4% | 54.5 |
| 10% PLA in Acetone | 0.50 | 10.34 | 0.06 | 0.46 | 0.6% | 16.5% | 27.9 |
| 10% PLA in Acetone | 1.00 | 10.36 | 0.08 | 0.46 | 0.8% | 16.5% | 20.9 |
| Lightweight Cup, 11 | 0.00 | 8.93 | −1.23 | 0.29 | −12.1% | −26.6% | 2.2 |
| point (9 g) | | | | | | | |

TABLE 1B
Double Laminated 16 oz. Paper Cup

| | | | | | | | Percent |
|---|---|---|---|---|---|---|---|
| | | | | | | | Strength |
| | | | | | | | increase/ |
| | Volume | Avg. Cup | Weight | | Percent | Percent | Percent |
| | Reinforcing | Weight | Added | Strength | Weight | Strength | Weight |
| Bead Material | agent (cc) | (g) | (g) | (lbs) | Increase | Increase | Increase |
| None - Control | 0.00 | 10.28 | 0.00 | 0.34 | | | |
| 10% PLA in Acetone | 0.25 | 10.32 | 0.04 | 0.44 | 0.4% | 29.6% | 83.1 |
| 10% PLA in Acetone | 0.50 | 10.34 | 0.06 | 0.46 | 0.6% | 36.9% | 62.6 |
| 10% PLA in Acetone | 1.00 | 10.36 | 0.08 | 0.46 | 0.8% | 37.9% | 49.7 |

Table 2 shows results of similar testing applied to an exemplary single laminated 16 oz. paper cup. The change in strength between 0.025 g of bead material added and 0.05 g of bead material added can demonstrate the single laminated cup can use more material to achieve a consistent bead 401, which can be due to absorption by the non-laminated surface.

TABLE 2
Single Laminated 16 oz. Paper Cup (Hot Cup)

| | | | | | | | Percent |
|---|---|---|---|---|---|---|---|
| | | | | | | | Strength |
| | | | | | | | increase/ |
| | Volume | Avg. Cup | Weight | | Percent | Percent | Percent |
| | Reinforcing | Weight | Added | Strength | Weight | Strength | Weight |
| Bead Material | agent (cc) | (g) | (g) | (lbs) | Increase | Increase | Increase |
| None - Control | 0.00 | 13.58 | 0.00 | 0.76 | | | |
| 10% PLA Stripe, not | 0.50 | 13.61 | 0.05 | 0.77 | 0.4% | 1.3% | 3.6 |
| connecting rim | | | | | | | |
| 10% PLA in Acetone | 0.25 | 13.56 | 0.025 | 0.82 | 0.2% | 7.9% | 42.9 |
| 10% PLA in Acetone | 0.50 | 13.58 | 0.05 | 0.86 | 0.4% | 13.2% | 35.7 |

Tables 3 shows the results of a similar testing procedure applied to an exemplary 30 oz. plastic cup produced by thermoforming followed by rim rolling, as described herein. The plastic cup was reinforced with 10% PLA in Acetone and/or a polyethylene wax. The plastic cup was 16.5 cm tall and sidewall strength was measured 4.1 cm from the top. Consistent with the paper cups above, the sidewall strength significantly increased with relatively little material.

TABLE 3
Thermoformed 30 oz. Plastic Cup

| | | | | | | | Percent |
|---|---|---|---|---|---|---|---|
| | | | | | | | Strength |
| | | | | | | | increase/ |
| | Volume | Avg. Cup | Weight | | Percent | Percent | Percent |
| | Reinforcing | Weight | Added | Strength | Weight | Strength | Weight |
| Bead Material | agent (cc) | (g) | (g) | (lbs) | Increase | Increase | Increase |
| None - Control | 0.00 | 23.03 | 0.00 | 1.26 | | | |
| 10% PLA in Acetone | 0.50 | 23.09 | 0.06 | 1.43 | 0.3% | 13.1% | 47.9 |
| Wax | 0.50 | 23.40 | 0.37 | 1.41 | 1.6% | 11.5% | 7.2 |

In addition to the specific embodiments claimed below, the disclosed subject matter is also directed to other embodiments having any other possible combination of the dependent features claimed below and those disclosed above. As such, the particular features disclosed herein can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A method to increase strength of a rolled rim container, comprising:
providing a container having a sidewall defining a perimeter, a base at a first end of the sidewall, and an opening defined at a second end of the sidewall opposite the base;
rolling a portion of the sidewall at the second end to form a rolled rim container having a rolled rim, the rolled rim defining an interface along the perimeter between an outer surface of the sidewall and an exposed surface of the rolled rim;
applying a bead material along at least a portion of the outer surface of the sidewall; and
curing the bead material to form a bead between the exposed surface of the rolled rim and the outer surface of the sidewall.

2. The method of claim 1, wherein the container is made of paper, plastic, composite, or foams thereof.

3. The method of claim 2, wherein the container is made of paper and is laminated on at least one side of the paper.

4. The method of claim 1, wherein at least the sidewall of the container is made of multiple walls separated by a gap.

5. The method of claim 1, wherein the bead material comprises at least one of a molten polymeric material, an emulsion, a solvent borne film-forming material, or a solid polymeric material.

6. The method of claim 1, wherein the bead material comprises a polyester.

7. The method of claim 6, wherein the polyester comprises polylactic acid (PLA).

8. The method of claim 6, wherein the bead material further comprises a solvent.

9. The method of claim 8, wherein the solvent comprises at least one of acetone or methylene chloride (MeCl).

10. The method of claim 1, wherein the bead material comprises 10% PLA in acetone.

11. The method of claim 1, wherein applying the bead material comprises applying the bead material along the entire perimeter of the sidewall.

12. The method of claim 1, wherein applying the bead material comprises applying the bead material along portions of the perimeter of the sidewall.

13. The method of claim 1, wherein rolling the portion of the sidewall occurs before applying the bead material, and wherein applying the bead material comprises applying the bead material along the interface between the exposed surface of the rolled rim and the outer surface of the sidewall.

14. The method of claim 1, wherein applying the bead material occurs before rolling the portion of the sidewall, and wherein applying the bead material comprises applying the bead material along a portion of the outer surface of the sidewall where the interface will be defined upon rolling the portion of the sidewall to form the rolled rim.

15. The method of claim 1, wherein applying the bead material comprises applying the bead material in fluid form.

16. The method of claim 1, wherein applying the bead comprises:
providing a dispenser to dispense the bead material;
rotating the rolled rim container relative the dispenser to dispense the bead material along the interface between the sidewall and the rolled rim.

17. The method of claim 16, wherein the dispenser is selected from at least one of an extruder, an injector, a pipette, a Pasteur pipette, an epoxy applicator, a glue applicator, or a syringe.

18. The method of claim 1, wherein applying the bead material comprises spraying the bead material along the interface between the exposed surface of the rolled rim and the outer surface of the sidewall.

19. The method of claim 18, wherein spraying the bead material comprises spraying the bead material with an atomizer.

20. The method of claim 1, wherein applying the bead material comprises immersing at least a portion of the interface in the bead material.

21. The method of claim 1, wherein the bead material is in a solid state, and applying the bead material further comprises:
applying the solid state bead material to the interface between the exposed surface of the rolled rim and the outer surface of the sidewall; and
melting, adhering, or expanding the solid state bead material to the interface between the exposed surface of the rolled rim and the outer surface of the sidewall.

22. The method of claim 1, wherein the bead material is applied at about 0.001-0.03 cubic centimeters (cc) of bead material per centimeter (cm).

23. The method of claim 22, wherein the bead material is applied at about 0.002-0.02 cc of bead material per cm.

24. The method of claim 1, wherein the bead comprises film webs or extensions extending along a portion of at least one of the exposed surface of the rolled rim or the outer surface of the sidewall.

25. The method of claim 1, wherein a strength to weight ratio of the rolled rim container having the bead formed between the exposed surface of the rolled rim and the outer surface of the sidewall is increased by at least 5% compared to a similar rolled rim container without a bead.

26. The method of claim 1, wherein a strength to weight ratio of the rolled rim container having the bead formed between the exposed surface of the rolled rim and the outer surface of the sidewall is increased by at least 10% compared to a similar rolled rim container without a bead.

27. The method of claim 1, wherein a strength to weight ratio of the rolled rim container having the bead formed between the exposed surface of the rolled rim and the outer surface of the sidewall is increased by at least 20% compared to a similar rolled rim container without a bead.

28. A rolled rim container comprising:
a sidewall having an outer surface defining a perimeter, a first end, and a second end, the second end having an opening defined thereat;
a base at the first end of the sidewall;
a rolled rim at the second end of the sidewall, the rolled rim having an exposed surface and defining an interface along the perimeter between the outer surface of the sidewall and the exposed surface of rolled rim; and
a bead formed at the interface between the exposed surface of the rolled rim and the outer surface of the sidewall.

29. The rolled rim container of claim 28, wherein the sidewall, base, and rolled rim each is made of at least one of paper or plastic.

30. The rolled rim container of claim 29, wherein the sidewall is made of paper, and further wherein the sidewall is laminated on at least one of the outer surface or an inner surface.

31. The rolled rim container of claim 28, wherein the bead comprises a bead material, the bead material comprising a polymeric material.

32. The rolled rim container of claim 31, wherein the bead material comprises a polyester.

33. The rolled rim container of claim 32, wherein the polyester comprises polylactic acid (PLA).

34. The rolled rim container of claim 31, wherein the bead material is applied in fluid form along the interface between the sidewall and the rolled rim.

35. The rolled rim container of claim 31, wherein the bead material further comprises a solvent.

36. The rolled rim container of claim 35, wherein the solvent comprises at least one of acetone or methylene chloride (MeCl).

37. The rolled rim container of claim 35, wherein the bead material comprises 10% PLA in acetone.

38. The rolled rim container of claim 34, wherein the bead material is applied at about 0.002-0.02 cc of bead material per cm.

39. The rolled rim container of claim 38, wherein the bead material is applied at about 0.001-0.03 cc of bead material per cm.

40. The rolled rim container of claim 31, wherein the bead material is applied in a solid state, and the bead is formed by melting, adhering, or expanding the solid state bead material to the interface between the sidewall and the rolled rim.

41. The rolled rim container of claim 28, wherein the bead is formed along the entire perimeter of the sidewall.

42. The rolled rim container of claim 28, wherein the bead is formed along portions of perimeter of the sidewall.

43. The rolled rim container of claim 28, wherein the bead comprises film webs or extensions extending along a portion of at least one of the exposed surface of the rolled rim or the outer surface of the sidewall.

44. The rolled rim container of claim 28, wherein a strength to weight ratio of the rolled rim container having the bead formed between the exposed surface of the rolled rim and the outer surface of the sidewall is increased by at least 5% compared to a similar rolled rim container without a bead.

45. The rolled rim container of claim 28, wherein a strength to weight ratio of the rolled rim container having the bead formed between the exposed surface of the rolled rim and the outer surface of the sidewall is increased by at least 10% compared to a similar rolled rim container without a bead.

46. The rolled rim container of claim 28, wherein a strength to weight ratio of the rolled rim container having the bead formed between the exposed surface of the rolled rim and the outer surface of the sidewall is increased by at least 20% compared to a similar rolled rim container without a bead.

47. A system to increase strength of a rolled rim container, comprising:
a mandrel adapted to receive a rolled rim container, the rolled rim container having a sidewall defining a perimeter, a base at a first end of the sidewall, an opening defined at a second end of the sidewall opposite the base, and a rolled rim at the second end of the sidewall defining an interface along the perimeter between an outer surface of the sidewall and an exposed surface of the rolled rim; and
a dispenser to apply a bead material along the interface between the sidewall and the rolled rim, the bead material being curable to form a bead between the exposed surface of the rolled rim and the outer surface of the sidewall,
wherein the mandrel and the dispenser are movable relative to each other.

48. The system of claim 47, wherein the dispenser is configured to apply the bead material along the entire perimeter of the sidewall.

49. The system of claim 47, wherein the dispenser is configured to apply the bead material along portions of the perimeter of the sidewall.

50. The system of claim 47, wherein the dispenser is configured to apply the bead material at about 0.001-0.03 cc of bead material per cm.

51. The system of claim 50, wherein the dispenser is configured to apply the bead material at about 0.002-0.02 cc of bead material per cm.

52. The system of claim 47, wherein the dispenser is configured to dispense the bead material along the interface between the sidewall and the rolled rim while the mandrel and the dispenser are rotating relative to each other.

53. The system of claim 47, wherein the dispenser is selected from at least one of an extruder, an injector, a pipette, a Pasteur pipette, an epoxy applicator, a syringe, or an atomizer.

54. The system of claim 47, wherein the dispenser is configured to spray the bead material along the interface between the exposed surface of the rolled rim and the outer surface of the sidewall.

55. The system of claim 47, wherein the dispenser is configured to immerse at least a portion of the interface in the bead material.

56. The system of claim 47, wherein the bead material is in a solid state, and further wherein the dispenser is configured to apply the solid state bead material to the interface between the sidewall and the rolled rim, further comprising:
at least one of a heat source or an adhesive source to secure the solid state bead material to the interface between the sidewall and the rolled rim.

57. The system of claim 47, wherein a strength to weight ratio of the rolled rim container having the bead formed between the exposed surface of the rolled rim and the outer surface of the sidewall is increased by at least 5% compared to a similar rolled rim container without a bead.

58. The system of claim 47, wherein a strength to weight ratio of the rolled rim container having the bead formed between the exposed surface of the rolled rim and the outer surface of the sidewall is increased by at least 10% compared to a similar rolled rim container without a bead.

59. The system of claim 47, wherein a strength to weight ratio of the rolled rim container having the bead formed between the exposed surface of the rolled rim and the outer surface of the sidewall is increased by at least 20% compared to a similar rolled rim container without a bead.
